(19) United States
(12) Patent Application Publication
(10) Pub. No.: US 2008/0117784 A1
(43) Pub. Date: May 22, 2008

(54) Boundary Detection Apparatus, Boundary Detection Method, Boundary Detection Program, and Information Recording Medium

(76) Inventors: Yoshimichi Nishio, Saitama (JP); Takaaki Ujiie, Saitama (JP); Hiroshi Someya, Saitama (JP); Yoshihiro Hashizuka, Saitama (JP); Hiroki Goto, Saitama (JP); Hideaki Tsurumi, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/791,639

(22) PCT Filed: Nov. 24, 2005
(86) PCT No.: PCT/JP05/21523

§ 371 Date: Aug. 20, 2007

(30) Foreign Application Priority Data
Nov. 26, 2004 (JP) 2004-341363

(51) Int. Cl. G11B 5/58

(52) U.S. Cl. 369/53.24

(57) ABSTRACT

A boundary detection apparatus is provided that can quickly and accurately detect an end of a recorded area even if there is a defect caused by a scratch or a extraneous matter adhered on the recording face of a CD, or the CD itself is decentered.

When it is detected that information is recorded at a predetermined dividing point B, a pickup is moved to a dividing point C located ahead seen from the dividing point B after moving. On the other hand, when it is detected that information is not recorded at the dividing point B, the pickup is moved to a dividing point A located on the opposite side from the dividing point B, and the pickup is further moved after the end containing range is ultimately determined. Thus, an end is detected.

### TECHNICAL FIELD

The present invention relates to the technical field of boundary detection apparatuses, boundary detection method, boundary detection programs, and information recording media, and, more particularly, to the technical field of a boundary detection apparatus and a boundary detection method for detecting a boundary between a recorded area in which information has been recorded and a non-recorded area in which information has not been recorded on a recording medium such as an optical disc, a boundary detection program to be used for the boundary detection, and an information recording medium on which the boundary detection program is recorded.

### BACKGROUND ART

So-called CDs (Compact Discs) have been conventionally used as read-only recording media on which tune information is recorded in such a manner that the tune information can be optically read to reproduce tunes. A reproduction apparatus for such CDs embodies various reproducing modes such as a random reproducing operation for reading the tune information from the CD at an arbitrary manner, not in the order of the recording performed on the CD, and reproducing the tunes corresponding to the tune information.

So as to realize the various reproducing modes, a conventional CD has a lead-in area in which a table of contents for the entire tune information recorded on the CD is recorded in advance. The table of contents is generally referred to as TOC (Table of Contents) information. More specifically, the TOC information includes the information as to the total number of tunes, the information as to the names of the tunes, the information as to the replay time of each tune, and the address information indicating the position of the top of the tune information as to each tune recorded on the CD. By reading the TOC information from the lead-in area before the tune information is read out, the recorded position of the tune information as to each tune on the CD can be recognized in advance, and accordingly, the above described random reproducing operation can be performed. In other words, if the TOC information cannot be detected before the tune information is reproduced, the recording start position of each tune cannot be obtained before the start of the reproduction, and therefore, the random reproducing operation cannot be performed.

In addition to the TOC information, sub-code information that indicates the relationship between the replay time elapsed since the top of each tune and the recorded position information (the address information) as to the tune information to be read from the CD at the elapsed replay time is buried in the tune information corresponding to the tune, so that a replay can be started at a desired point in the tune recorded on the CD.

In recent years, not only the read-only CDs, but also recordable CDs such as CD-R (CD-Recordable) discs on which the user can record tune information after purchasing have widely spread. A user who has purchased a recordable CD can record tune information on the recordable CD. After desired tune information is recorded also on such a recordable CD, TOC information corresponding to the contents of all the recorded tune information is created as a rule and recorded in a recordable area such as a lead-in area of the CD. Here, the process of recording the TOC information having the contents corresponding to the contents of the recorded tune information on the CD on which the tune information has been recorded is generally referred to as a finalizing process.

By performing the finalizing process, the TOC information corresponding to all the tune information recorded on the CD is recorded, so that the tune information recorded on the recordable CD can be reproduced through the above described random reproducing operation, like the above described tune information recorded on the above described read-only CD. In addition to that, the tune information recorded on the recordable CD can be reproduced in a reproduction apparatus for read-only CDs in the same manner as for a read-only CD.

On the other hand, a today's personal computer can record tune information or the like on the above described recordable CDs with the use of an optical recording device built in the personal computer. However, many of the operating systems (basic system software) for general personal computers terminate the recording of tune information on a recordable CD, without performing the finalizing process. There is an increasing number of cases where CDs having tune information recorded thereon but have not been subject to the finalizing process appear in public places.

Unless the end of the tune information recorded area on a CD on which tune information has been recorded by a personal computer is detected in advance, it is substantially difficult to search operation for the tune information later (a so-called track search operation) or to perform the random reproducing operation. This is because the track search or the random reproducing operation exhausts an unnecessarily long period of time when the end of the tune information recorded area has not been detected, and as a result, the track search and the random reproducing operation cannot substantially be performed.

To counter this problem, the following techniques have been suggested as the methods for detecting the end of a recorded area on a recordable CD on which the finalizing process has not been performed.

The first conventional technique concerns a method for detecting the end of the recorded area by reproducing the tune information as to each tune already recorded on the above described CD, starting from the inner periphery side of the CD toward the outer periphery side of the CD, or by repeating a track jump operation for the number of recorded tracks preset on the CD.

The second conventional technique is disclosed in Reference 1. As disclosed in Reference 1, to shorten the time required for detecting the end of the recorded area, the pickup is moved in the radial direction of the CD, with the focus servo loop being in a closed state and the tracking servo being in an open state. During the movement, an on-track signal (i.e. a signal indicating the existence of a recording track formed on the CD) is detected, and the pickup is temporarily moved from the recorded area to a non-recorded area (or the pickup is jumped to a non-recorded area) to detect the boundary between the recorded area and non-recorded area. The boundary between the recorded area and the non-recorded area is then detected, and the pickup is moved as if being returned from the position of the non-recorded area to the recorded area. In this manner, the end of the recorded area is detected.

Reference 1: Japanese Patent Application Laid-Open No. 2001-243638

### DISCLOSURE OF THE INVENTION

### Problems to be Solved by the Invention

By the above described first conventional technique, however, it is necessary to reproduce all the tune information recorded on the CD, or to perform the track jump in all the area on the CD. As a result, a very long period of time is required before the end is detected.

By the second conventional technique, when the on-track signal cannot be detected, the pickup is determined to have been jumped onto the non-recorded area, and the pickup is returned to the recorded area. If there is a scratch or a defect due to a extraneous matter adhered on the recording face on the way to the non-recorded area, the on-track signal cannot be detected in the corresponding area. In such a case, the pickup is erroneously determined to have been jumped onto the non-recorded area, though it still remains in the recording area. Also, when the CD has the tune information recorded up to the outermost periphery thereof and is largely decentered, the pickup that has moved to the outer periphery might jump out of the CD, and cannot be moved reversely to the recorded area thereafter.

Therefore, the present invention was developed, with the above problems being taken into consideration. An object of the present invention is to provide a boundary detection apparatus and a boundary detection method that can quickly and accurately detect an end of a recorded area even if there is a defect caused by a scratch or a extraneous matter adhered on the recording face of a CD or the CD is decentered, a boundary detection program to be utilized for the boundary detection, and an information recording medium on which the boundary detection program is recorded.

### Means to Solve the Problems

In order to solve the above problems, the invention according to claim 1 relates to a boundary detection apparatus that detects a boundary between a recorded area in which information is recorded and a non-recorded area in which the information is not recorded on a recording medium that has a format in which information recording is performed in a predetermined direction,

the boundary detection apparatus comprising:

detecting means for determining whether the information has been recorded in a recordable area of the information of the recording medium;

first moving means for moving the detecting means to one of dividing points that are preset by dividing stepwise the recordable area by a predetermined dividing number, the first moving means moving the detecting means to another one of the dividing points located ahead of the dividing point seen in the predetermined direction from the dividing position after moving when the detecting means detects that the information has been recorded at the dividing point after moving, the first moving means repeating the moving of the detecting means for the plurality of the dividing points;

second moving means for moving the detecting means to another one of the dividing points located on the opposite side of the one of the dividing points for which it is detected that the information has not been recorded in the predetermined direction when the detecting means detects that the information has not been recorded at the one of the dividing points during the movement of the detecting means by the first moving means, the second moving means repeating the moving of the detecting means for the plurality of the dividing points located on the opposite side in the predetermined direction; and

third moving means for further moving the detecting means from the dividing point of the moved detecting means to which the detecting means has been moved by either of the first moving means or the second moving means, and detecting the boundary.

In order to solve the above problems, the invention according to claim 19 relates to a boundary detection method for detecting a boundary between a recorded area in which information is recorded and a non-recorded area in which the information is not recorded on a recording medium that has a format in which information recording is performed in a predetermined direction,

the boundary detection method comprising:

a detecting step for detecting whether the information has been recorded in a recordable area of the recording medium, the detecting step being performed by a detecting means for detecting the information from the recording medium;

the first moving step for moving the detecting means to one of dividing points that are set by dividing stepwise the recordable area by a predetermined dividing number, and moving the detecting means to another one of the dividing points located ahead of the one of the dividing points seen in the predetermined direction from the dividing position after moving when the detecting means detects that the information has been recorded at the point after the movement, the moving of the detecting means being repeated for the plurality of the dividing points;

the second moving step for moving the detecting means to another one of the dividing points located on the opposite side of the one of the dividing points for which it is detected that the information has not been recorded in the predetermined direction when the detecting means detects that the information has not been recorded at the one of the dividing points during the movement of the detecting means in the first moving step, the moving of the detecting means being repeated for the plurality of the dividing points located on the opposite side in the predetermined direction; and

the third moving step for further moving the detecting means from the dividing point of the moved detecting means to which the detecting means has been moved in the first moving step or the second moving step, and detecting the boundary.

In order to solve the above problems, the invention according to claim 20 relates to a boundary detection program that is to be executed in a computer provided in a boundary detection apparatus that detects a boundary between a recorded area in which information has been recorded and a non-recorded area in which the information has not been recorded on a recording medium that has a format in which information recording is performed in a predetermined direction,

the boundary detection program being executed to cause the computer to function as:

first moving means for moving detecting means for determining whether the information has been recorded in a recordable area of the recording medium, to one of dividing points that are set by dividing stepwise the recordable area by a predetermined dividing number, the first moving means moving the detecting means to another one of the dividing points located ahead of the one of the dividing points seen in the predetermined direction from the dividing position after moving when the detecting means detects that the information has been recorded at the point after the movement, the first moving means repeating the moving of the detecting means for the plurality of the dividing points;

second moving means for moving the detecting means to another one of the dividing points located on the opposite side of the one of the dividing points for which it is detected that the information has not been recorded in the predetermined direction when the detecting means detects that the information has not been recorded at the one of the dividing points during the movement of the detecting means by computer which functions as the first moving means, the second moving means repeating the moving of the detecting means for the plurality of the dividing points located on the opposite side in the predetermined direction; and

third moving means for further moving the detecting means from the dividing point of the moved detecting means to which the detecting means has been moved by the computer functioning as the first moving means or the computer functioning as the second moving means, and detecting the boundary.

In order to solve the above problems, the invention according to claim 21 relates to an information recording medium on which the boundary detection program according to claim 20 is recorded in such a manner that the program can be read by the computer.

### BRIEF DESCRIPTION OF THE DRAWINGS

FIG. 1 is a block diagram schematically showing the structure of an information reproduction apparatus in accordance with embodiments of the present invention;

FIGS. 2A, 2B, and 2C illustrate examples of end position detecting operations in accordance with the first embodiment: FIG. 2A is the first example; FIG. 2B is the second example; and FIG. 2C is the third example;

FIG. 3 is a flowchart showing an end position detecting operation in accordance with the first embodiment;

FIG. 4 is a flowchart showing an end position detecting operation in accordance with the second embodiment;

FIGS. 5A and 5B illustrate an end position detecting operation in accordance with the third embodiment: FIG. 5A shows an example of an area dividing method; and FIG. 5B is a flowchart showing the end position detecting operation in accordance with the third embodiment;

FIG. 6 is a flowchart showing an end position detecting operation in accordance with a fourth embodiment;

FIG. 7 is a flowchart showing an end position detecting operation in accordance with a fifth embodiment; and

FIG. 8 is a flowchart showing an end position detecting operation in accordance with a sixth embodiment.

### EXPLANATION OF REFERENCE NUMERALS

1 Pickup
2 Spindle motor
3 Servo driver
4 Servo signal processing unit
5 Amplifier
6 Demultiplexer
7 Audio decoder
8 Image decoder
9, 10 D/A converter
11 Memory
12 CPU
13 Operating unit
14 Display
S Information reproduction apparatus
A, B, C, AA, BB, CC Dividing point
I Innermost periphery point
O Outermost periphery point
SP Irradiation point
DK, DK2 Optical disc
LB Optical beam

### BEST MODE FOR CARRYING OUT THE INVENTION

The following is a description of preferred embodiments of the present invention, with reference to the accompanying drawings. In each of the following embodiments, the present invention is applied to cases where an end of an information recorded area on an optical disc is to be detected in an information reproduction apparatus that detects recorded information from the optical disc such as a CD and reproduces the corresponding tune or image. On the optical disc, a piece or pieces of tune information or image information (hereinafter, referred to simply as recorded information) to be reproduced is recorded, but TOC information having the contents corresponding to the recorded information is not recorded. On the optical disc of each embodiment, the information recording is started from the inner periphery side and is continued toward the outer periphery side.

### (I) FIRST EMBODIMENT

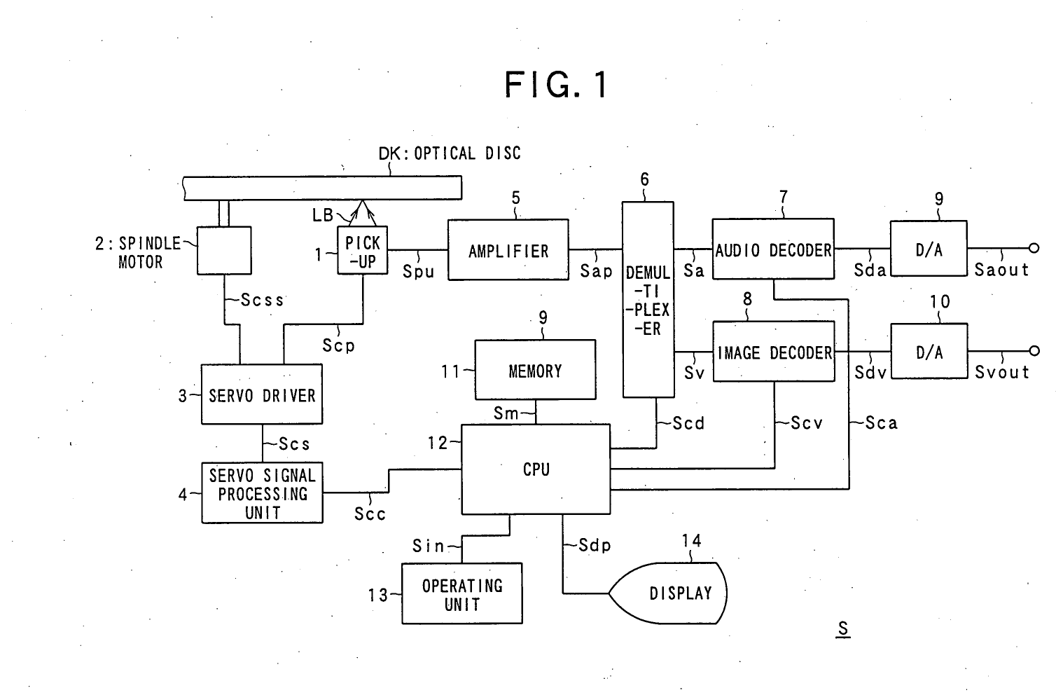

Referring first to FIGS. 1 through 3, the first embodiment of the present invention will be described.

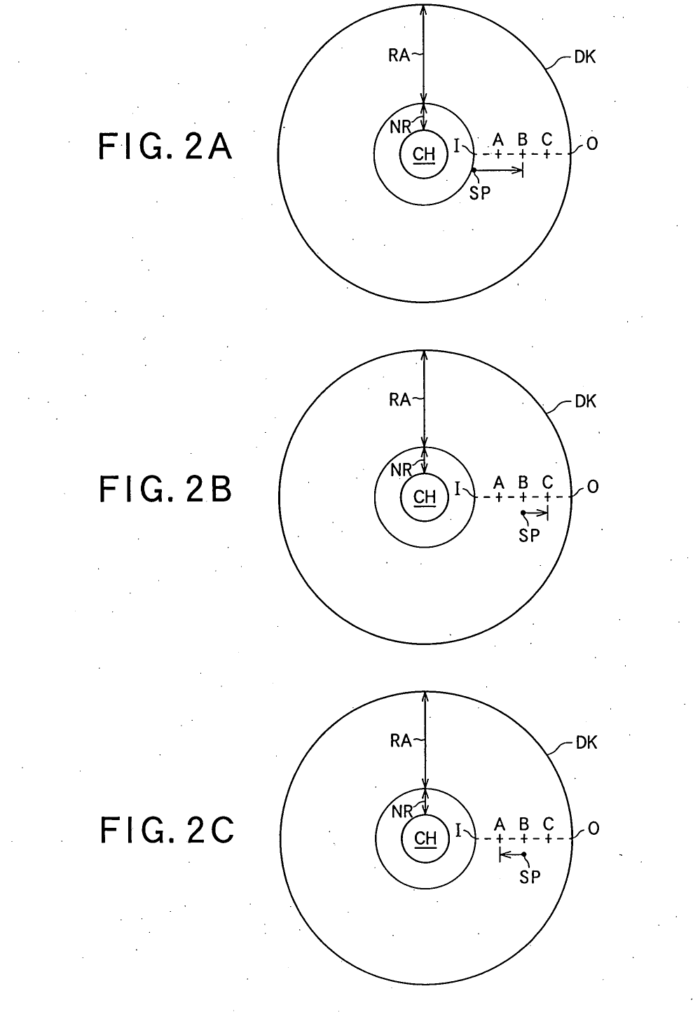

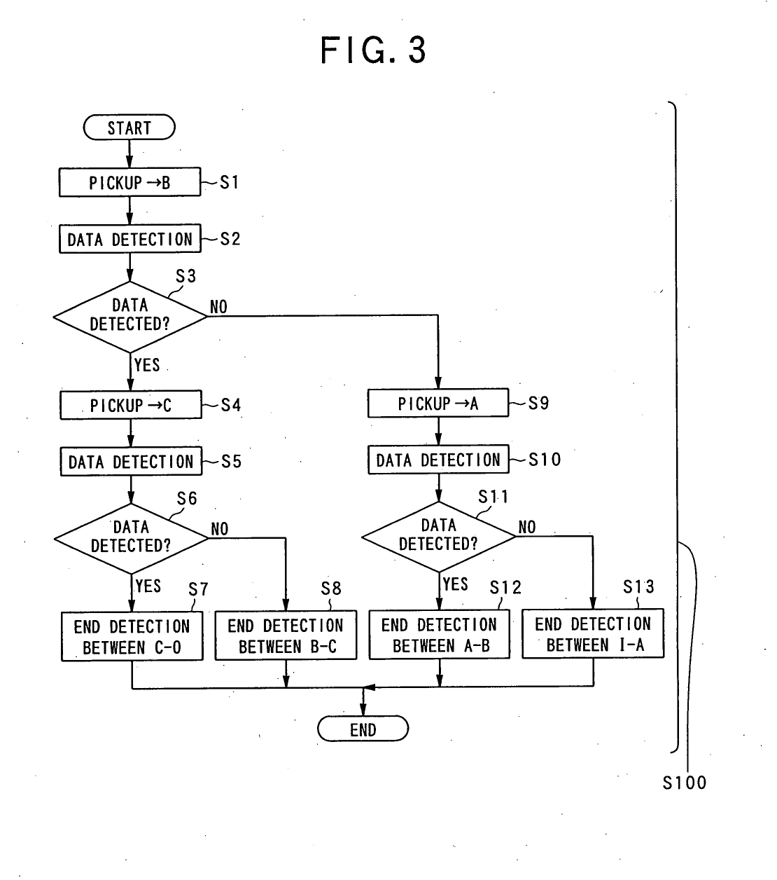

FIG. 1 is a block diagram schematically showing the structure of an information reproduction apparatus in accordance with the first embodiment of the present invention. FIG. 2 illustrates an end detecting operation of the information reproduction apparatus. FIG. 3 is a flowchart showing the end detecting operation of the information reproduction apparatus.

As shown in FIG. 1, the information reproduction apparatus S in accordance with the first embodiment includes a pickup 1 as a detecting means, a spindle motor 2, a servo driver 3, a servo signal processing unit 4, an amplifier 5, a demultiplexer 6, an audio decoder 7, an image decoder 8, D/A (Digital Analog) converters 9 and 10, a memory 11, a CPU 12 as the first moving means, the second moving means, the third moving means, and a setting means, an operating unit 13, and a display 14.

Next, an operation of the entire apparatus will be described.

An optical disc DK mounted on the information reproduction apparatus S is fixed in the spindle motor 2 and rotated at a preset speed. When recorded information is reproduced from the rotating optical disc DK, the pickup 1 emits a reproduction light beam LB of a predetermined intensity, and the reflection light is received by a light detector (not shown) in the pickup 1. The light detector then generates a detection signal Spu that has amplitude and the likes varying with the intensity of the received reflection light, and outputs the detection signal Spu to the amplifier 5.

The amplifier 5 amplifies the detection signal Spu by a predetermined amplification factor, and outputs an amplification signal Sap to the demultiplexer 6.

Based on a control signal Scd from the CPU 12, the demultiplexer 6 separately extracts an audio signal Sa corresponding to audio information containing tune information and an image signal Sv corresponding to image information from the amplification signal Sap, and outputs the audio signal Sa and the image signal Sv to the audio decoder 7 and the image decoder 8, respectively.

Based on a control signal Sca from the CPU 12, the audio decoder 7 decodes the audio signal Sa independently extracted from the amplification signal Sap by the demultiplexer 6, in accordance with a predetermined decoding method. The audio decoder 7 then generates a decoded audio signal Sda, and outputs the decoded audio signal Sda to the D/A converter 9.

The D/A converter 9 converts the decoded audio signal Sda into an analog signal, to generate an audio output signal Saout as an analog signal. The D/A converter 9 then outputs the audio output signal Saout to a speaker or the like (not shown) that emits sound.

On the other hand, based on a control signal Scv from the CPU 12, the image decoder 8 decodes the audio signal Sv independently extracted from the amplification signal Sap by the demultiplexer 6, in accordance with a predetermined decoding method. The image decoder 8 then generates a decoded image signal Sdv, and outputs the decoded image signal Sdv to the D/A converter 10.

The D/A converter 10 converts the decoded image signal Sdv into an analog signal, to generate an image output signal Svout as an analog signal. The D/A converter 10 then outputs the image output signal Svout to a display or the like (not shown) that displays an image.

The rotation speed of the spindle motor 2 is controlled through a servo operation based on a control signal Scss from the servo driver 3, so that the optical disc DK is rotated at a constant rotation speed.

Further, the irradiation point on the optical disc DK onto which the light beam LB is emitted is controlled through a combination of a focus servo operation performed for controlling the irradiation point in a direction perpendicular to the recording layer of the optical disc DK and a tracking servo operation performed for controlling the irradiation point in a direction parallel to the recording layer (or in a radial direction of the optical disc DK). Those two servo operations are initiated by a control signal Scp output from the servo driver 3 respectively to the actuator for focus servo operations and the actuator for tracking servo operations. In addition to that, when the irradiation point of the light beam LB is moved in the radial direction of the optical disc DK beyond the movement range of an objective lens (not shown) during a tracking servo operation (for example, when a track jump that will be described later is performed), a carriage servo operation for moving the entire pickup 1 in the radial direction of the optical disc DK is performed. This carriage servo operation is also performed based on the control signal Scp.

Therefore, the servo driver 3 generates and outputs the control signals Scp and Scss to the pickup 1 and the spindle motor 2 respectively, so that the necessary servo operations can be performed on the pickup 1 and the spindle motor 2, based on a control signal Scs from the servo signal processing unit 4.

Based on a control signal Scc from the CPU 12, the servo signal processing unit 4 generates and outputs the control signal Scs to the servo driver 3, so that the generation of the control signals Scss and Scp from the servo driver 3 can be correctly performed.

Concurrently with the above operations of the respective components, the CPU 12 generates and outputs the control signals Scc, Scd, Scv, and Sca to the respective components based on an operation signal Sin from the operating unit 13, so that operations suitable for the contents can be performed. In this manner, the CPU 12 integrally controls the respective components. Also, the information necessary for the collective control is output as a memory signal Sm to the memory 11, and is temporarily stored in the memory 11. Whenever necessary, the necessary information is read out as the memory signal Sm from the memory 11, and is output to the CPU 12, which uses the information for an appropriate operation. Further, the information that needs to be noticed to the user, such as the operating state of the information reproduction apparatus S, is displayed on the display 14, based on a display signal Sdp from the CPU 12.

Referring to FIGS. 1 through 3, an operation of detecting an end position on the optical disc DK to be performed mainly by the servo signal processing unit 4 and the servo driver 3 in accordance with the first embodiment will be described.

In the end position detecting operation in accordance with the first embodiment, the data recording area on the optical disc DK is first divided into four areas by three dividing points. More specifically, when the optical disc DK is formed with a center hole CH for securing the optical disc DK to the spindle motor 2, a non-recording area NR located in the innermost periphery, and a data recording area RA in which recording information is to be actually recorded, as shown in FIG. 2A, the area between the innermost periphery point I and the outermost periphery point O of the data recording area RA is virtually divided by three dividing points A, B, and C in advance in the end position detecting operation in accordance with the first embodiment.

The dividing points A, B, and C are not actually recorded on the optical disc DK, but are virtually set during a servo operation performed for preparing for the end position detecting operation in accordance with the first embodiment.

The specific locations of the dividing points A, B, and C in the data recording area RA may be set simply by dividing the length of the data recording area RA in the radial direction by four, and the alphabets A, B, and C may be allotted to the dividing points from the inner periphery side. Alternatively, the dividing points A, B, and C may be set at the points determined by dividing the total information recording capacity of the data recording area RA by four, and the alphabets A, B, and C are allotted to the respective points in the data recording area RA in the radial direction from the inner periphery side. In the latter case, if information is recorded on the optical disc DK being rotated at a constant rotation speed, and the information is reproduced from the optical disc being rotated at a constant rotation speed, the information recording density does not vary between the inner periphery side and the outer periphery side on the optical disc DK. Accordingly, the relationship among the distance IA between the innermost periphery point I and the dividing point A, the distance AB between the dividing point A and the dividing point B, the distance BC between the dividing point B and the dividing point C, and the distance CO between the dividing point C and the outermost periphery point O is expressed as:

IA=AB=BC=CO

On the other hand, if information is recorded on the optical disc DK being rotated at a constant linear speed, and the information is reproduced from the optical disc DK being rotated at a constant rotation speed, the relationship is expressed as:

IA>AB>BC>CO

With the dividing points A, B, and C being preset in the end position detecting operation in accordance with the first embodiment, the irradiation point SP of the light beam LB from the pickup 1 onto the optical disc DK is moved from the innermost periphery immediately to the dividing point B by moving the pickup 1 through a carriage servo operation, as shown in FIGS. 2 and 3 (step S1).

It should be noted that, in the following description, the generation of the detection signal Sp while the light beam LB is being emitted is stopped or the emission of the light beam LB is stopped, so that no recorded information is detected from the optical disc DK during the immediate movement of the irradiation point SP between the innermost periphery point I and the dividing point A, during the immediate movement of the irradiation point SP between the dividing point A and the dividing point B, during the immediate movement of the irradiation point SP between the dividing point B and the dividing point C, and during the immediate movement of the irradiation point SP between the dividing point C and the outermost periphery point O.

To measure the movement distance in each immediate movement, the location of destination of the irradiation point SP may be detected by the servo signal processing unit 4 measuring the time elapsed from the start of the movement. Alternatively, when the motor for carriage servo operations is a stepping motor, the location of the destination may be detected by the servo signal processing unit 4 measuring the movement distance from the start of the movement of the irradiation point SP based on the rotation speed or the like of the stepping motor.

Further, during each immediate movement, only the tracking servo loop for tracking servo operations may be put into an open state, or the focus servo loop for focus servo operations as well as the tracking servo loop may also be put into an open state.

When the irradiation point SP reaches the dividing point B, a check is made to detect whether recorded information exists at the dividing point B (steps S2, S3). Here, the search of the recorded information in steps S2 and S3 is performed to detect whether recorded information exists by emitting the light beam LB onto the dividing point B and, the presence of the recorded information (i.e. information is recorded at the detected point) is determined based on the reflection light of the light beam LB by detecting a tracking error signal or a signal (a so-called on-track signal) indicating that the light beam LB is emitted onto the recording track (the search for recording information in steps S5 and S6 and steps S10 and S11 is the same as the search in steps S5 and S6). If recorded information is detected at the dividing point B (step S3; YES), the end of recorded information is located between the dividing point B and the outermost periphery point O, since information has been recorded at the dividing point B. Therefore, the irradiation point SP is moved from the dividing point B immediately to the dividing point C (step S4), as shown in FIGS. 2 and 3.

When the irradiation point SP reaches the dividing point C, a check is made to detect whether recorded information exists at the dividing point C (steps S5, S6). If recorded information is detected at the dividing point C (step S6; YES), the end of recorded information is located between the dividing point C and the outermost periphery point O, since information has been recorded at the dividing point C. The irradiation point SP is then moved from the dividing point C sequentially to the outermost periphery point O, with the light beam LB being emitted onto the optical disc DK. The definitive end of the recorded area is detected by the first conventional technique or the second conventional technique, for example (step S7). The end position detecting operation in accordance with the first embodiment is then completed. After that, with the use of the detected end position, TOC information for recorded information reproduction is generated, and actual recorded information reproduction is started.

On the other hand, if recorded information is not detected at the dividing point C in the determination of step S6 (step S6; NO), recorded information exists at the dividing point B, but recorded information does not exist at the dividing point C. Accordingly, it is confirmed that the end of recorded information exists between the dividing point B and the dividing point C. The irradiation point SP is returned immediately to the dividing point B and is sequentially moved to the dividing point C, with the light beam LB being emitted onto the optical disc DK. The definitive end of the recorded area is then detected by using the first conventional technique or the second conventional technique, for example (step S8). The end position detecting operation in accordance with the first embodiment is then completed.

If recorded information is not detected at the dividing point B in the determination of step S3 (step S3; NO), information has not been recorded at the dividing point B, and accordingly the end of the recorded information exists between the innermost periphery point I and the dividing point B. Therefore, the irradiation point SP is moved from the dividing point B immediately to the dividing point A (step S9), as shown in FIGS. 2 and 3.

When the irradiation point SP reaches the dividing point A, a check is made to detect whether recorded information exists at the dividing point A (steps S10, S11). If recorded information is detected at the dividing point A (step S11; YES), information has already been recorded at the dividing point A, and accordingly the end of recorded information exists between the dividing point A and the dividing point B. Therefore, the irradiation point SP is sequentially moved from the dividing point A to the dividing point B, with the light beam LB being emitted onto the optical disc DK. The definitive end of the recorded area is then detected by using the first conventional technique or the second conventional technique, for example (step S12). The end position detecting operation in accordance with the first embodiment is then completed.

On the other hand, if recorded information is not detected at the dividing point A in the determination of step S11 (step S11; NO), information has not been recorded at the dividing point A, and accordingly the end of the recorded information exists between the innermost periphery point I and the dividing point A. Therefore, the irradiation point SP is returned immediately to the innermost periphery point I and is sequentially moved to the dividing point A, with the light beam LB being emitted onto the optical disc DK. The definitive end of the recorded area is then detected by the first conventional technique or the second conventional technique, for example (step S13). The end position detecting operation in accordance with the first embodiment is then completed.

As described above, in the end position detecting operation in accordance with the first embodiment, when information recorded at the preset dividing point B is detected, the pickup 1 is moved to the dividing point C located ahead seen from the dividing point B. On the other hand, when information recorded at the dividing point B is not detected, the pickup 1 is moved to the dividing point A located in the opposite direction from the dividing point B, and the pickup 1 is further moved after the end containing range is definitely determined. The end is then detected. In this manner, an operation of detecting information from the optical disc DK is not performed during the movement between two of the dividing points A, B, and C, and a search for information recorded on the optical disc DK is repeated only at the dividing points, so as to detect the definitive end position. Accordingly, even if there is a scratch or a extraneous matter adhered on the optical disc DK, or the optical disc DK is decentered, the position of the boundary between the recorded area and the non-recorded area, or the end of the recorded area, can be quickly detected with precision.

Also, when the movement of the pickup 1 between the dividing points is controlled by detecting the movement time or the movement distance, the movement of the pickup 1 can be controlled through a simple operation.

Furthermore, when the preset dividing points in accordance with the length of the data recording area RA in the radial direction of the optical disc DK are used, the boundary can be quickly detected with precision in accordance with the shape of the optical disc DK itself.

Furthermore, when the positions determined by dividing the total recording capacity of the optical disc DK are used as the dividing points according to the recording capacity, the dividing points can be set with precision, regardless of the shape of the optical disc DK. Thus, an end position can be quickly detected with precision.

### (II) SECOND EMBODIMENT

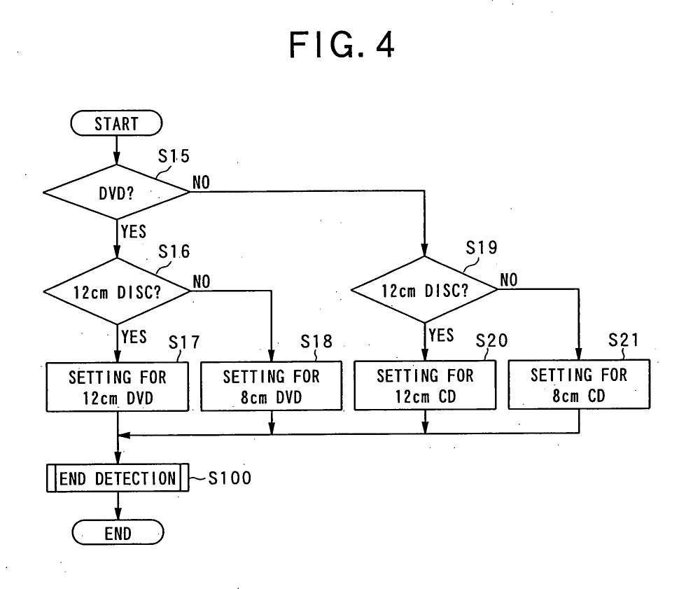

Referring to FIGS. 1, 2, and 4, the second embodiment as another embodiment of the present invention will be described. FIG. 4 is a flowchart showing an end detecting operation to be performed in an information reproduction apparatus in accordance with the second embodiment.

In the above described first embodiment, the present invention is applied to an end detecting operation in a recorded area on a recordable optical disc DK having only one recording layer. In the second embodiment described below, however, the size of an optical disc mounted on the information reproduction apparatus (whether the diameter of the optical disc is 12 centimeters or 8 centimeters), and the information recording density on the optical disc (whether the mounted optical disc is a CD or DVD (Digital Versatile Disc)) are also determined.

The information reproduction apparatus in accordance with the second embodiment has the same structure as the information reproduction apparatus in accordance with the first embodiment. Therefore, similar components are denoted by same reference numerals, and explanation of them is omitted herein. In the second embodiment and each of the embodiments described below, the entire operation shown in the flowchart of FIG. 3 is referred to as step S100.

To perform an end position detecting operation in accordance with the second embodiment, the following four cases are taken into consideration in advance: a case where the optical disc mounted on the information reproduction apparatus is a DVD of 12 centimeters in diameter; a case where the optical disc is a DVD of 8 centimeters in diameter; a case where the optical disc is a CD of 12 centimeters in diameter; and a case where the optical disc is a CD of 8 centimeters in diameter. The dividing point information, which indicates the same three dividing points as the dividing points A, B, and C of the first embodiment, is prepared for the four types of optical discs. Accordingly, 12 types (4 types×3 dividing points) of dividing point information are preset and are stored in a nonvolatile area in the memory 11, for example. A suitable piece of the dividing point information corresponding to each type of optical disc is read out when necessary, so that the data recording area of the optical disc is divided into four areas by the three dividing points corresponding to the type of the optical disc. An end position detecting operation is then performed.

After the end position detecting operation in accordance with the second embodiment is started, with the dividing point information corresponding to the respective optical disc types being stored in the memory 11, a search is first performed in a lead-in area or the like, so as to determine whether the optical disc mounted on the information reproduction apparatus in accordance with the second embodiment is a DVD (step S15).

If the mounted optical disc is a DVD (step S15; YES), a check is made to detect whether the diameter of the DVD is 12 centimeters (step S16). Here, an optical sensor is placed at a location 12 centimeters away from the center of the spindle motor 2 shown in FIG. 1, and, if the optical sensor senses that an optical disc is mounted, the optical disc has a diameter of 12 centimeters. In this manner, the size of the DVD is also checked.

If the diameter of the mounted DVD is detected to be 12 centimeters in the determination of step S16 (step S16; YES), the dividing point information that indicates the three preset dividing points on the assumption that the mounted optical disc is a DVD having a diameter of 12 centimeters is read out from the memory 11 and is set in the servo signal processing unit 4 (step S17). With the three dividing positions being set as the dividing positions A, B, and C from the inner periphery side, the end position detecting operation shown in FIG. 3 is performed (step S100).

On the other hand, if the diameter of the mounted DVD is detected not to be 12 centimeters in the determination of step S16 (step S16; NO), the dividing point information that indicates the three preset dividing points on the assumption that the mounted optical disc is a DVD having a diameter of 8 centimeters is read out from the memory 11 and is set in the servo signal processing unit 4 (step S18). With the three dividing positions being set as the dividing positions A, B, and C from the inner periphery side, the end position detecting operation shown in FIG. 3 is performed (step S100).

If the mounted optical disc is determined not to be a DVD in the determination of step S15 (step S15; NO), the mounted optical disc is determined to be a CD, and a check is made to detect whether the diameter of the CD is 12 centimeters by the same checking method as in step S16 (step S19).

If the diameter of the mounted CD is detected to be 12 centimeters in the determination of step S19 (step S19; YES), the dividing point information that indicates the three preset dividing points on the assumption that the mounted optical disc is a CD having a diameter of 12 centimeters is read out from the memory 11 and is set in the servo signal processing unit 4 (step S20). With the three dividing positions being set as the dividing positions A, B, and C from the inner periphery side, the end position detecting operation shown in FIG. 3 is performed (step S100).

On the other hand, if the diameter of the mounted CD is detected not to be 12 centimeters in the determination of step S19 (step S19; NO), the dividing point information that indicates the three preset dividing points on the assumption that the mounted optical disc is a CD having a diameter of 8 centimeters is read out from the memory 11 and is set in the servo signal processing unit 4 (step S21). With the three dividing positions being set as the dividing positions A, B, and C from the inner periphery side, the end position detecting operation shown in FIG. 3 is performed (step S100).

As described above, as well as the same effect as the end position detecting operation of the first embodiment, the end position detecting operation in accordance with the second embodiment has the effect of controlling the movement of the pickup 1, using the dividing points that are set based on the recording density of the optical disc (whether the optical disc is a DVD or CD) and the size of the optical disc. Thus, an end position can be quickly detected with precision, in accordance with the size of the optical disc on which the information to be searched for the end position is recorded.

### (III) THIRD EMBODIMENT

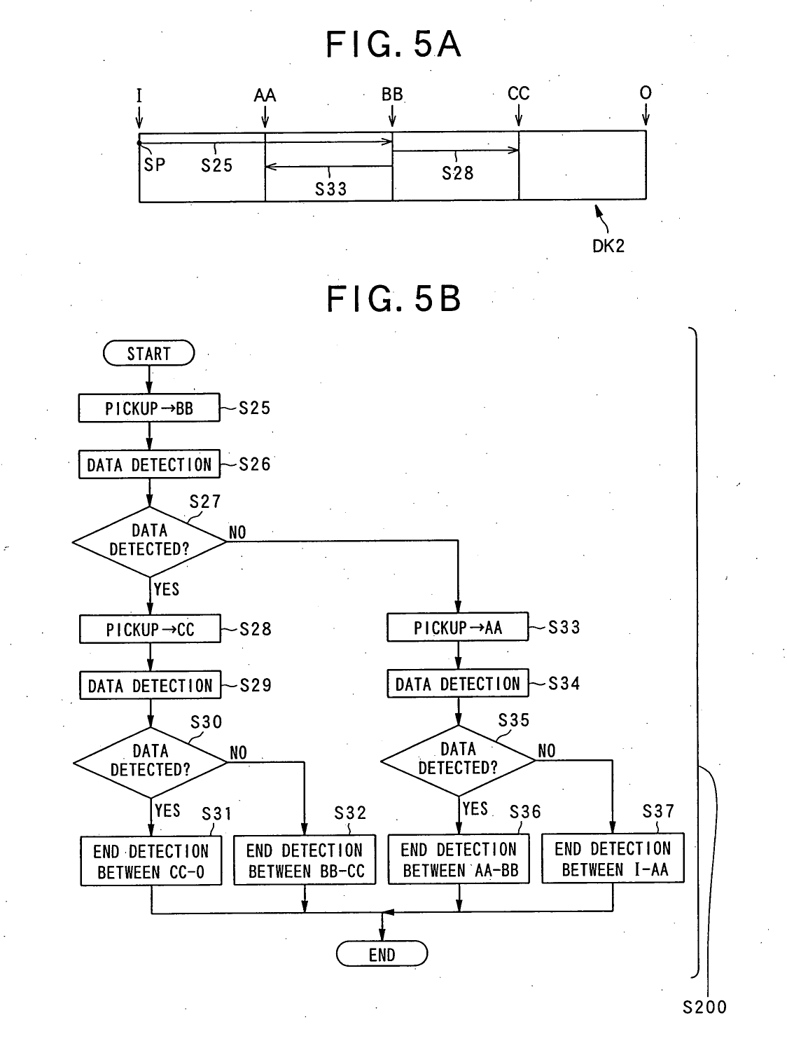

Referring now to FIGS. 1 and 5, the third embodiment as yet another embodiment of the present invention will be described. FIG. 5 shows an end detecting operation to be performed in an information reproduction apparatus in accordance with the third embodiment.

In each of the above described first and second embodiments, the present invention is applied to a detection of the end of the recorded area on the recordable optical disc DK having only one recording layer. In the third embodiment described below, however, an optical disc having two or more recording layers is mounted on an information reproduction apparatus that can reproduce information from each of the recording layers of the optical disc having two or more recording layers on which information can be recorded, and the end of a recorded area on the mounted optical disc is to be detected.

In the third embodiment and each of the embodiments described below, information recording is performed in ascending order, starting from the recording on the first recording layer among a plurality of recording layers formed in an optical disc.

The information reproduction apparatus in accordance with the third embodiment has the same structure as the information reproduction apparatus in accordance with the first embodiment. Therefore, similar components are denoted by same reference numerals, and explanation of them is omitted herein. In the fourth embodiment and each of the embodiments described below, the operation shown in the flowchart of FIG. 5B is referred to as step S200.

In the end position detecting operation in accordance with the third embodiment, the data recording area on an optical disc DK2 having a plurality of recording layers is first divided into four areas by three dividing points. More specifically, as shown in FIG. 5A, in the data recording area formed over the recording layers of the optical disc DK2, the area between the innermost periphery point I (or the innermost periphery point of the first recording layer) and the outermost periphery point O (or the outermost periphery point of the last recording layer) is virtually divided by three dividing points AA, BB, and CC in advance.

The dividing points AA, BB, and CC are not actually recorded on the optical disc DK2, but are virtually set during a servo operation performed for preparing for the end position detecting operation in accordance with the third embodiment.

The specific locations of the dividing points AA, BB, and CC in the data recording area may be set simply by dividing the total length of the data recording area in the radial direction by four, and the alphabets AA, BB, and CC may be allotted to the dividing points from the inner periphery side of the first recording layer. Alternatively, the dividing points AA, BB, and CC may be set at the points determined by dividing the total information recording capacity of the data recording area by four, and the alphabets AA, BB, and CC are allotted to the respective points in the data recording area in the radial direction from the inner periphery side of the first recording layer. In the latter case, if information is recorded on the optical disc DK2 being rotated at a constant rotation speed, and the information is reproduced from the optical disc DK2 being rotated at a constant rotation speed, the information recording density does not vary between the inner periphery side and the outer periphery side on the optical disc DK2. Accordingly, the relationship among the distance IA′ between the innermost periphery point I and the dividing point AA, the distance AB′ between the dividing point AA and the dividing point BB, the distance BC′ between the dividing point BB and the dividing point CC, and the distance CO′ between the dividing point CC and the outermost periphery point O is expressed as:

IA′=AB′=BC′=CO′

On the other hand, if information is recorded on the optical disc DK2 being rotated at a constant linear speed, and the information is reproduced from the optical disc DK2 being rotated at a constant rotation speed, the relationship is expressed as:

IA′>AB′>BC′>CO′

With the dividing points AA, BB, and CC being preset in the end position detecting operation in accordance with the third embodiment, the irradiation point SP of the light beam LB from the pickup 1 onto the optical disc DK2 is moved from the innermost periphery point I immediately to the dividing point BB by moving the pickup 1 itself through a carriage servo operation, as shown in “S25” in FIG. 5(s) (step S25).

It should be noted that, in the following description, the generation of the detection signal Sp while the light beam LB is being emitted is stopped or the emission of the light beam LB is stopped, so that no recorded information is detected from the optical disc DK2 during the immediate movement of the irradiation point SP between the innermost periphery point I and the dividing point AA, during the immediate movement of the irradiation point SP between the dividing point AA and the dividing point BA, during the immediate movement of the irradiation point SP between the dividing point BB and the dividing point CC, and during the immediate movement of the irradiation point SP between the dividing point CC and the outermost periphery point O.

To measure the movement distance in each immediate movement, the location of destination of the irradiation point SP may be detected by the servo signal processing unit 4 measuring the time elapsed from the start of the movement. Alternatively, when the motor for carriage servo operations is a stepping motor, the location of the destination may be detected by the servo signal processing unit 4 measuring the movement distance from the start of the movement of the irradiation point SP based on the rotation speed or the like of the stepping motor.

Further, during each immediate movement, only the tracking servo loop for tracking servo operations may be put into an open state, or the focus servo loop for focus servo operations as well as the tracking servo loop may be put into an open state.

When the irradiation point SP reaches the dividing point BB, a check is made to detect whether recorded information exists at the dividing point BB (steps S26, S27). Here, the search of the recorded information in steps S2 and S3 is performed to detect whether recorded information exists (or whether information has been recorded at the location) by emitting the light beam LB onto the dividing point BB and, based on the reflection light of the light beam LB, detecting a tracking error signal or an on-track signal (the search for recording information in steps S29 and S30 and steps S34 and S35 is the same as the search in steps S26 and S27). If there is information recorded at the dividing point BB (step S27; YES), the end of recorded information is located between the dividing point BB and the outermost periphery point O, since recorded information exists at the dividing point BB. Therefore, the irradiation point of the light beam is moved from the dividing point BB immediately to the dividing point CC (step S28), as shown in “S28” in FIG. 5(a).

When the irradiation point SP reaches the dividing point CC, a check is made to detect whether recorded information exists at the dividing point CC (steps S29, S30). If recorded information is detected at the dividing point CC (step S30; YES), the end of recorded information is located between the dividing point CC and the outermost periphery point O, since information has been recorded at the dividing point CC. The irradiation point SP is then moved from the dividing point CC sequentially to the outermost periphery point O, with the light beam LB being emitted onto the optical disc DK2. The end of the recorded area is detected by the first conventional technique or the second conventional technique, for example (step S31). The end position detecting operation in accordance with the third embodiment is then completed. After that, with the use of the detected end position, TOC information for recorded information reproduction is generated, and actual recorded information reproduction is started.

On the other hand, if recorded information is not detected at the dividing point CC in step S30 (step S30; NO), recorded information exists at the dividing point BB, but recorded information does not exist at the dividing point CC. Accordingly, it is confirmed that the end of recorded information exists between the dividing point BB and the dividing point CC. The irradiation point SP is returned immediately to the dividing point BB and is sequentially moved to the dividing point CC, with the light beam LB being emitted onto the optical disc DK2. The definitive end of the recorded area is then detected by the first conventional technique or the second conventional technique, for example (step S32). The end position detecting operation in accordance with the third embodiment is then completed.

If recorded information is not detected at the dividing point BB in the determination of step S27 (step S27; NO), information has not been recorded at the dividing point BB, and accordingly the end of the recorded information exists between the innermost periphery point I and the dividing point BB. Therefore, the irradiation point SP is moved from the dividing point BB immediately to the dividing point AA (step S33), as shown “S33” in FIG. 5(a).

When the irradiation point SP reaches the dividing point AA, a check is made to detect whether recorded information exists at the dividing point AA (steps S34, S35). If recorded information is detected at the dividing point AA (step S35; YES), information has already been recorded at the dividing point AA, and accordingly the end of recorded information exists between the dividing point AA and the dividing point BB. Therefore, the irradiation point SP is sequentially moved from the dividing point AA to the dividing point BB, with the light beam LB being emitted onto the optical disc DK2. The definitive end of the recorded area is then detected by the first conventional technique or the second conventional technique, for example (step S36). The end position detecting operation in accordance with the third embodiment is then completed.

If recorded information is not detected at the dividing point AA in the determination of step S35 (step S35; NO), information has not been recorded at the dividing point AA, and accordingly the end of the recorded information exists between the innermost periphery point I and the dividing point AA. Therefore, the irradiation point SP is returned immediately to the innermost periphery point I and is sequentially moved to the dividing point AA, with the light beam LB being emitted onto the optical disc DK. The definitive end of the recorded area is then detected by the first conventional technique or the second conventional technique, for example (step S37). The end position detecting operation in accordance with the third embodiment is then completed.

As described above, in the end position detecting operation in accordance with the third embodiment, when information recorded at the dividing point BB preset on the assumption that a plurality of recording layers are provided is detected, the pickup 1 is moved to the dividing point CC located ahead seen from the dividing point BB. When information recorded at the dividing point BB is not detected, the pickup 1 is moved to the dividing point AA located in the opposite direction from the dividing point BB, and the pickup 1 is further moved after the end containing range is definitely determined. The end is then detected. In this manner, an operation of detecting information from the optical disc DK2 is not performed during the movement between two of the dividing points AA, BB, and CC, and a search for information recorded on the optical disc DK2 is repeated only at the dividing points, so as to finally detect the definite end position. Accordingly, even if there is a scratch or a extraneous matter adhered on the optical disc DK, or the optical disc DK itself is decentered, the position of the end of the recorded area can be quickly detected with precision.

Also, when the movement of the pickup 1 between the dividing points is controlled by detecting the movement time or the movement distance, the movement of the pickup 1 can be controlled through a simple operation.

Furthermore, when the preset dividing points in accordance with the length of the data recording area in the radial direction of the optical disc DK2 are used, a boundary can be quickly detected with precision in accordance with the shape of the optical disc DK2.

Further, when the positions determined by dividing the total recording capacity of the respective recording layers of the optical disc DK2 are used as the dividing points according to the recording capacity, the dividing points can be set with precision, regardless of the shape of the optical disc DK2. Thus, an end position can be quickly detected with precision. In this case, in addition to the total recording capacity, the number of recording layers formed in the optical disc DK2 may be taken into account when the dividing points are set. In this manner, suitable dividing points can be set, regardless of the shape of the optical disc DK2 having a plurality of recording layers, and a boundary can be quickly detected with precision.

### (IV) FOURTH EMBODIMENT

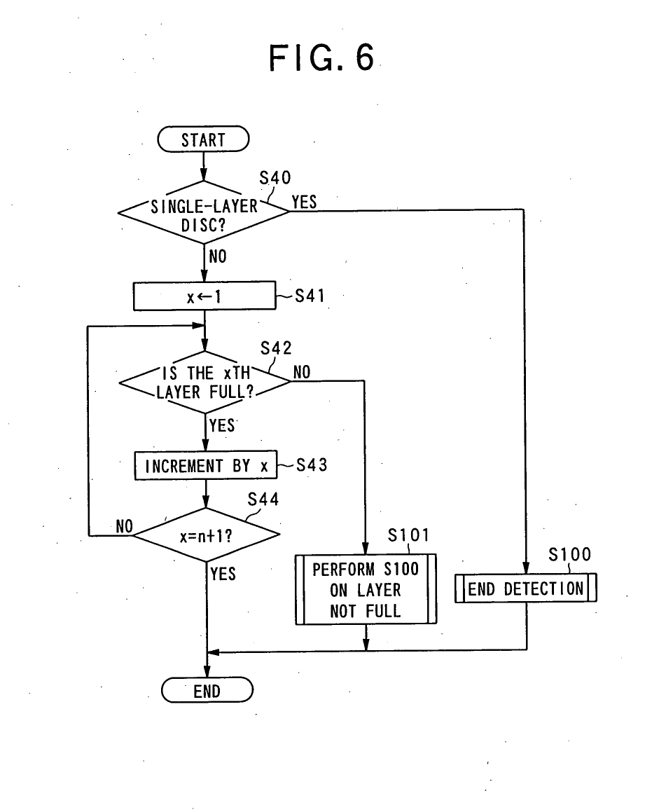

Referring now to FIGS. 1 and 6, a fourth embodiment will be described as yet another embodiment of the present invention. FIG. 6 is a flowchart showing an end detecting operation to be performed in an information reproduction apparatus in accordance with the fourth embodiment.

In the third embodiment, the end of the recorded area of an optical disc that has a plurality of recording layers and is mounted on an information reproduction apparatus is detected in the information reproduction apparatus that can reproduce information from each recording layer of an optical disc having a plurality of recording layers. The fourth embodiment described below concerns another method for detecting the position of the end of the recorded area on the optical disc DK2 of the third embodiment.

Since the information reproduction apparatus in accordance with the fourth embodiment has the same structure as the information reproduction apparatus in accordance with the first embodiment, similar components are denoted by same reference numerals, and explanation of them is omitted here.

In the fourth embodiment, the same dividing points as the dividing points A, B, and C of the first embodiment are set on each one recording layer.

With the dividing points being set on each recording layer, an end position detecting operation in accordance with the fourth embodiment is started. First, a check is made to detect whether the number of recording layers of the optical disc mounted on the information reproduction apparatus of the fourth embodiment is one (step S40). If the number of recording layers is one (step S40; YES), an end position detecting operation that is exactly the same as the end position detecting operation of the first embodiment is performed on the single recording layer (step S100).

If the number of recording layers of the mounted optical disc is determined to be more than one in the determination of step S40 (step S40; NO), a parameter x that indicates the number allotted to the subject recording layer is set to “1” (step S41), and a check is made to detect whether information has been recorded to the outermost periphery point on the xth recording layer (step S42). Here, the procedure of step S42 is performed by moving the irradiation point of a light beam B to the outermost periphery point on the xth recording layer to be checked, and determining whether recorded information is detected from the outermost periphery point.

If there is no information recorded at the outermost periphery point on the xth recording layer in the determination of step S42 (step S42; NO), the end of the recorded area exists at some point on the xth recording layer, and therefore, an end position detecting operation that is exactly the same as the end position detecting operation of the first embodiment is performed on the xth recording layer (step S101).

On the other hand, if there is information recorded at the outermost periphery point on the xth recording layer in the determination of step S42 (step S42; YES), the value of the parameter x is incremented by “1” (step S43). Further, a check is made to detect whether the incremented value of the parameter x is equal to the value obtained by adding “1” to the total number n of recording layers of the currently mounted optical disc (step S44). If the present value of the parameter x is not “n+1” (step S44; NO), the operation returns to step S42, to repeat the procedures of steps S42 through S44 for the recording layer represented by the present value of the parameter x.

If the present value of the parameter x is “n+1” (step S44; YES), the end of the recorded area has been detected from one of the recording layers of the currently mounted optical disc. The end position detecting operation in accordance with the fourth embodiment is then completed.

As described above, in the end position detecting operation in accordance with the fourth embodiment, when information has not been recorded on the entire first recording layer, the first recording layer is searched for the end position. When information has been recorded on the entire first recording layer, a recording layer not having information recorded in the entire recording area thereof is sequentially detected, and an end position detecting operation is performed on the detected recording layer. Thus, the end position in an optical disc having a plurality of recording layers can be quickly detected with precision.

Further, since a boundary is detected from the first recording layer when information has not been recorded on the entire first recording layer, the end position in an optical disc having a plurality of recording layers can be quickly detected with precision.

Furthermore, since the end position is detected from another recording layer when information has been recorded on the entire first recording layer of the optical disc DK having a plurality of recording layers, a boundary in the optical disc DK2 having a plurality of recording layers can be quickly detected with precision.

Also, when information has been recorded on a mth (m≠1) recording layer but not on the entire mth recording layer, the mth recording layer is searched for a boundary. Thus, a desired boundary can be quickly detected with precision from a recording medium having a plurality of recording layers.

### (V) FIFTH EMBODIMENT

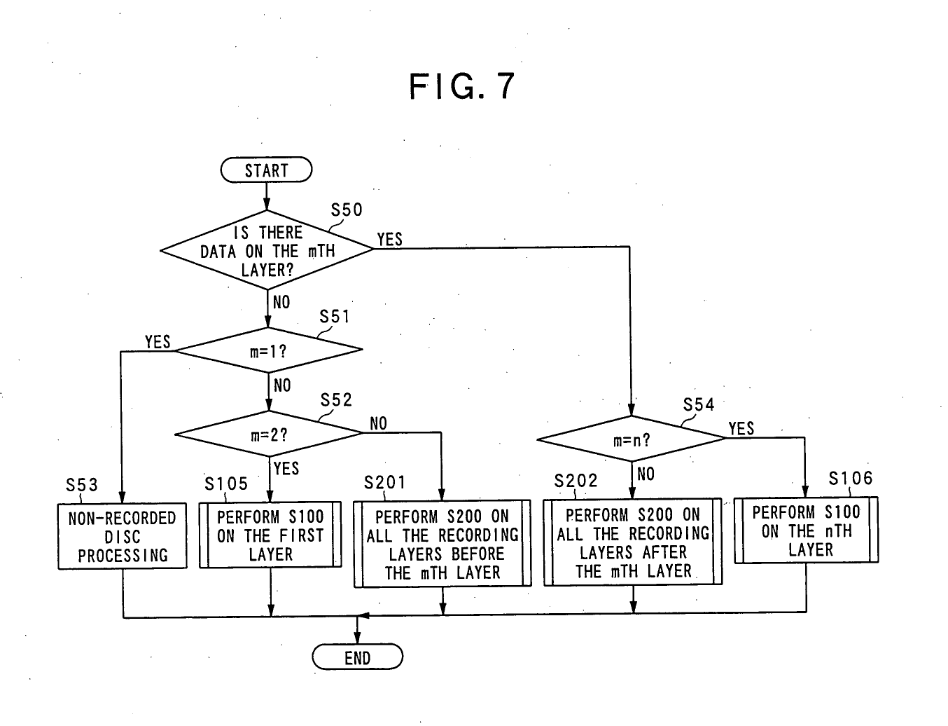

Referring now to FIGS. 1 and 7, a fifth embodiment will be described as yet another embodiment of the present invention. FIG. 7 is a flowchart showing an end detecting operation to be performed in an information reproduction apparatus in accordance with the fifth embodiment.

In the above described third and fourth embodiments, the end of the recorded area of an optical disc that has two or more recording layers and is mounted on an information reproduction apparatus is detected in the information reproduction apparatus that can reproduce information from each recording layer of an optical disc having a plurality of recording layers. The fifth embodiment described below concerns another method for detecting the position of the end of the recorded area on the optical disc DK2 of the third embodiment.

Since the information reproduction apparatus in accordance with the fifth embodiment has the same structure as the information reproduction apparatus in accordance with the first embodiment, similar components are denoted by same reference numerals, and explanation of them is omitted here.

In the fifth embodiment, the same dividing points as the dividing points A, B, and C of the first embodiment are set on each of the first recording layer and the recording layer (the nth recording layer, n being a natural number of 2 or larger) on which information is to be recorded last. The same dividing points as the dividing points AA, BB, and CC according to the third embodiment are set on each of the other recording layers, and the dividing point information indicating the respective dividing points is recorded in advance in a nonvolatile area in the memory 11.

With the dividing points being set on each recording layer or each recording layer group, an end position detecting operation in accordance with the fifth embodiment is started. First, a check is made to detect whether information has been recorded at any point on a mth recording layer (m being a parameter indicating the number allotted to the subject recording layer and being a natural number) in an optical disc mounted on the information reproduction apparatus in accordance with the fifth embodiment (step S50). Here, the procedure of step S50 is performed by moving the irradiation point of a light beam B to the innermost periphery point on the mth recording layer to be checked, and determining whether recorded information is detected from the innermost periphery point.

If there is information recorded on the mth recording layer in the determination of step S50 (step S50; YES), a check is made to detect whether the present value of the parameter m is equal to the number n allotted to the last recording layer (step S54). If the present value of the parameter m is determined not to be equal to the number n allotted to the last recording layer (step S54; NO), the operation of step S200 shown in FIG. 5B is performed on all the recording layers between the mth recording layer and the nth recording layer indicated by the current parameter m, so as to detect the position of the end (step S202).

If the present value of the parameter m is determined to be equal to the number n allotted to the last recording layer in the determination of step S54 (step S54; YES), the operation of step S100 shown in FIG. 3 is performed on the nth recording layer, so as to detect the end position (step S106).

On the other hand, if there is no information recorded on the mth recording layer in the determination of step S50 (step S50; NO), Determination is made whether the present value of the parameter m is equal to “1” (step S51). If the present value of the parameter m is determined to be equal to “1” (step S51; YES), no information has been recorded on the first recording layer, therefore, the display 14 displays a message to notify that the optical disc mounted on the information reproduction apparatus of the fifth embodiment is a non-recorded disc (or that there is not (an end of) a recorded area) (step S53), and the end position detecting operation in accordance with the fifth embodiment is completed.

If the present value of the parameter m is determined not to be equal to “1” in the determination of step S51 (step S51; NO), a check is made to detect whether the present value of the parameter m is equal to “2” (step S52). If the present value of the parameter m is determined to be equal to “2” (step S52; YES), information has not been recorded on the second recording layer or the end of the recorded area exists on the first recording layer. Therefore, an end position detecting operation that is exactly the same as the end position detecting operation in accordance with the first embodiment is performed on the first recording layer (step S105).

On the other hand, if the present value of the parameter m is determined not to be equal to “2” in the determination of step S52 or the present value of the parameter m is “3” or larger (step S52; NO), the operation of step S200 shown in FIG. 5B is performed on all the recording layers between the first recording layer and the mth recording layer represented by the present value of the parameter m, and the end position is detected (step S201).

As described above, in the end position detecting operation in accordance with the fifth embodiment, when information has not been recorded on the second recording layer, the first recording layer is searched for the end position. Thus, a boundary in the optical disc DK2 having a plurality of recording layers can be quickly detected with precision.

Further, since a check is made to detect whether there is information recorded on the nth recording layer on which information is to be recorded last on the optical disc DK2 having a plurality of recording layer, and an end position is detected from the nth recording layer when information has been recorded on the nth recording layer, a desired boundary in the optical disc DK2 having a plurality of recording layers can be quickly detected with precision.

Furthermore, since each of the first through (m−1)th recording layers is searched for the end position after a check is made to detect whether information has been recorded on the mth recording layer, a desired boundary in the optical disc DK2 having three or more recording layers can be quickly detected with precision.

### (VI) SIXTH EMBODIMENT

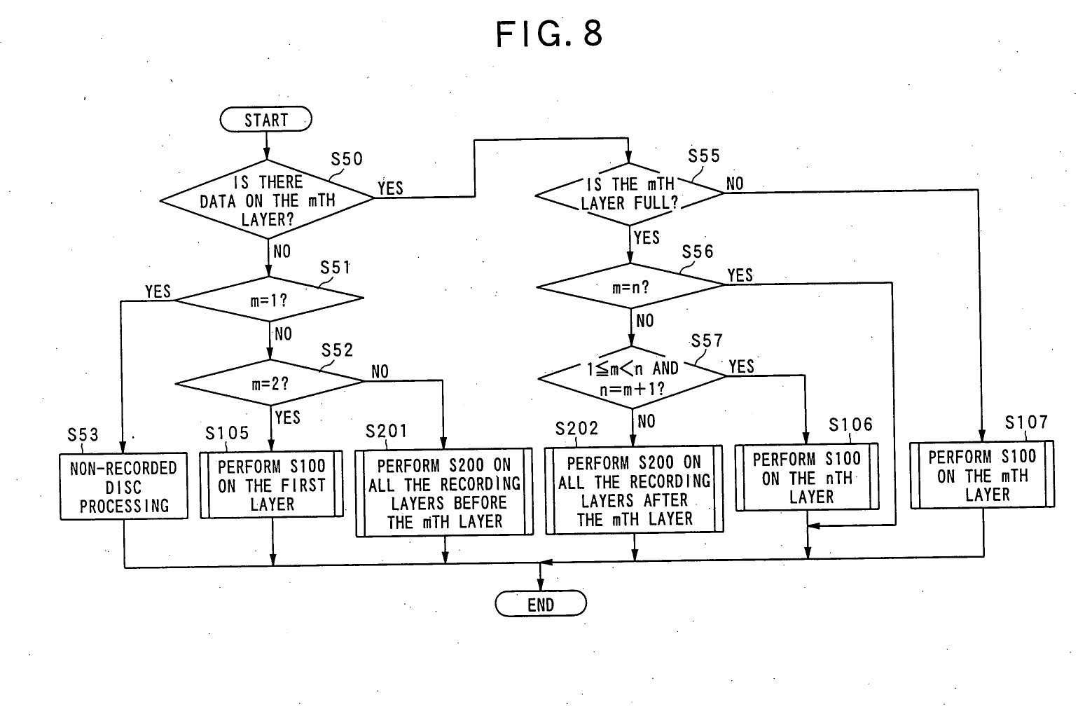

Lastly, referring to FIGS. 1 and 8, a sixth embodiment will be described as yet another embodiment of the present invention. FIG. 8 is a flowchart showing an end detecting operation to be performed in an information reproduction apparatus in accordance with the sixth embodiment.

In the above described third through fifth embodiments, the end of the recorded area of an optical disc that has two or more recording layers and is mounted on an information reproduction apparatus is detected in the information reproduction apparatus that can reproduce information from each recording layer of an optical disc having a plurality of recording layers. The sixth embodiment described below concerns another method for detecting the position of the end of the recorded area on the optical disc DK2 of the third embodiment.

Since the information reproduction apparatus in accordance with the sixth embodiment has the same structure as the information reproduction apparatus in accordance with the first embodiment, similar components are denoted by same reference numerals, and explanation of them is omitted here. Also, in the flowchart shown in FIG. 8, the same procedures as those in the flowchart shown in FIG. 7 are denoted by the same step numbers as those in the flowchart shown in FIG. 7.

In the sixth embodiment, as same in the fifth embodiment, the same dividing points as the dividing points A, B, and C of the first embodiment are set on each of the first recording layer and the nth recording layer on which information is to be recorded last. The same dividing points as the dividing points AA, BB, and CC according to the third embodiment are set on each of the other recording layers, and the dividing point information indicating the respective dividing points is recorded in advance in a nonvolatile area in the memory 11.

With the dividing points being set on each recording layer or each recording layer group, an end position detecting operation in accordance with the sixth embodiment is started. First, the procedures of steps S50 through S53 and steps S105 and S201 that are the same as those in the end position detecting operation (see FIG. 7) in accordance with the fifth embodiment are performed.

On the other hand, if there is information recorded on the mth recording layer in the determination of step S50 (step S50; YES), a check is made to detect whether information has been recorded up to the outermost periphery point on the mth recording layer (step S55). If there is no information recorded at the outermost periphery point on the mth recording layer (step S55; NO), the operation of step S100 shown in FIG. 3 is performed on the nth recording layer, and an end position is detected (step S107).

If there is information recorded at the outermost periphery point on the mth recording layer in the determination of step S55 (step S55; YES), a check is made to detect whether the present value of the parameter m is equal to the number n allotted to the last recording layer (step S56). If the present value of the parameter m is determined to be equal to the number n allotted to the last recording layer (step S56; YES), information has been recorded on all the recording layers up to the nth recording layer (or that there is not an end in the recorded area). Therefore, the end position detecting operation in accordance with the sixth embodiment is completed as it is.

If the present value of the parameter m is determined not to be equal to the number n allotted to the last recording layer in the determination of step S56 (step S56; NO), a check is made to determine whether the present value of the parameter m is equal to or larger than “1” and is smaller than “n”, and whether “n” is equal to “m+1” (step S57).

If the present value of the parameter m is determined not to be equal to or larger than “1” and is smaller than “n”, or “n” is determined not to be equal to “m+1” in the determination of step S57 (step S57; NO), the procedure of step S202 that is the same as step S202 of the end position detecting operation in accordance with the fifth embodiment (see FIG. 7) is performed.

If the present value of the parameter m is determined to be equal to or larger than “1” and is smaller than “n”, or “n” is determined to be equal to “m+1” in the determination of step S57 (step S57; YES), the procedure of step S106 that is the same as step S106 of the end position detecting operation in accordance with the fifth embodiment (see FIG. 7) is performed.

As described above, in the end position detecting operation in accordance with the sixth embodiment, after recorded information is detected from the mth recording layer, each of the recording layers following the mth recording layer is searched for an end position. Thus, a desired boundary on each recording layer in the optical disc DK2 having a plurality of recording layers can be quickly detected with precision.

Also, when information has been recorded on the entire mth recording layer of the optical disc DK2 having a plurality of recording layers, an end position is detected from the (m+1)th recording layer and the recording layers following the (m+1)th recording layer. Thus, a desired boundary on each recording layer in the optical disc DK2 having a plurality of recording layers can be quickly detected with precision.

The programs corresponding to the flowcharts shown in FIGS. 3 through 8 may be recorded on an information recording medium such as a flexible disc or a hard disc, or may be obtained via the Internet or the like and be stored. Those programs may be read and executed by a general-purpose computer, and the computer may be used as the CPU 12 of each of the embodiments.

1: A boundary detection apparatus that detects a boundary between a recorded area in which information is recorded and a non-recorded area in which the information is not recorded on a recording medium that has a format in which information recording is performed in a predetermined direction,
the boundary detection apparatus comprising:
a detecting device which determines whether the information has been recorded in a recordable area of the information of the recording medium;
a first moving device which moves the detecting device to one of dividing points that are preset by dividing stepwise the recordable area by a predetermined dividing number, the first moving device moving the detecting device to another one of the dividing points located ahead of the dividing point seen in the predetermined direction from the dividing position after moving when the detecting device detects that the information has been recorded at the dividing point after moving, the first moving device repeating the moving of the detecting device for the plurality of the dividing points;
a second moving device which moves the detecting device to another one of the dividing points located on the opposite side of the one of the dividing points for which it is detected that the information has not been recorded in the predetermined direction when the detecting device detects that the information has not been recorded at the one of the dividing points during the movement of the detecting device by the first moving device, the second moving device repeating the moving of the detecting device for the plurality of the dividing points located on the opposite side in the predetermined direction; and
a third moving device which further moves the detecting device from the dividing point of the moved detecting device to which the detecting means has been moved by either of the first moving device or the second moving device, and detecting the boundary.

2: The boundary detection apparatus according to claim 1,
wherein the first moving device and the second moving device controls movements of the detecting device, based on a period of time during which the detecting device has moved.

3: The boundary detection apparatus according to claim 1,
wherein the first moving device and the second moving device control movements of the detecting device, based on a distance for which the moving device has moved.

4: The boundary detection apparatus according to claim 1, further comprising
a setting device which sets each of the dividing points on the recording medium, based on the size of the recording medium,
wherein the first moving device and the second moving device move the detecting device, based on each of the set dividing points.

5: The boundary detection apparatus according to claim 1, further comprising
a setting device which sets each of the dividing points on the recording medium, based on the recording density of the information recorded on the recording medium,
wherein the first moving device and the second moving device move the detecting device, based on each of the set dividing points.

6: The boundary detection apparatus according to claim 1, wherein:
the recording medium is a disc-shaped recording medium; and
the dividing points are points aligned in a radial direction of the disc-shaped recording medium.

7: The boundary detection apparatus according to claim 6, wherein:
the recording medium is a disc-shaped recording medium that includes a plurality of recording layers on which the information is recorded; and
the dividing points are set on the recording layers in accordance with a length obtained by dividing stepwise the total length obtained by adding all lengths of the radius of the recording layers.

8: The boundary detection apparatus according to claim 1,
wherein the dividing points are set on the recording medium in accordance with a recording capacity obtained by dividing stepwise the total recording capacity of the recording medium.

9: The boundary detection apparatus according to claim 8, wherein:
the recording medium is a recording medium that includes a plurality of recording layers on which the information is recorded; and
the dividing points are set on the recording layers in accordance with a recording capacity obtained by dividing stepwise a total recording capacity obtained by adding all the recording capacities of the recording layers.

10: The boundary detection apparatus according to claim 8, wherein:
the recording medium is a recording medium that includes a plurality of recording layers on which the information is recorded; and
the dividing points are set on the recording layers in accordance with a recording capacity obtained by dividing stepwise a total recording capacity by the number of the recording layers, the total recording capacity being obtained by adding all the recording capacities of the recording layers.

11: The boundary detection apparatus according to claim 1, wherein:
the recording medium is a recording medium that is formed with a plurality of stacked recording layers;
the detecting device detects whether the information has been recorded on the entire first recording layer that is the recording layer on which the information is to be recorded first; and
the boundary detection apparatus further comprises a control device which controls the first moving device, the second moving device, and the third moving device to detect the boundary in the first recording layer, when the information has not been recorded on the entire first recording layer.

12: The boundary detection apparatus according to claim 1, wherein:
the recording medium is a recording medium that is formed with a plurality of stacked recording layers;
the detecting device detect whether the information has been recorded on the second recording layer that is the recording layer on which the information is to be recorded second in the recording medium; and
the boundary detection apparatus further comprises a control device which controls the first moving device, the second moving device, and the third moving device to detect the boundary in the recording layer on which the information is to be recorded first in the recording medium, when the information has not been recorded on the second recording layer.

13: The boundary detection apparatus according to claim 1, wherein:
the recording medium is a recording medium that is formed with n (n being a natural number of 2 or larger) of stacked recording layers;
the detecting device detects whether the information has been recorded on the nth recording layer on which the information is to be recorded last in the recording medium; and
the boundary detection apparatus further comprises a control device which controls the first moving device, the second moving device, and the third moving device to detect the boundary from the nth recording layer, when the information has been recorded on the nth recording layer.

14: The boundary detection apparatus according to claim 1, wherein:
the recording medium is a recording medium that is formed with n (n being a natural number of 3 or larger) of stacked recording layers;
the detecting device detects whether the information has been recorded on a mth (m being a natural number of 2 or large) recording layer on which the information is to be recorded mth in the recording medium; and
the boundary detection device further comprises a control device which controls the first moving device, the second moving device, and the third moving device to detect the boundary from the mth recording layer, when the information has been recorded on the mth recording layer and when the information has not been recorded on the entire mth recording layer.

15: The boundary detection apparatus according to claim 7, wherein:
the recording medium is a recording medium that is formed with three or more stacked recording layers;
the detecting device detects whether the information has been recorded on the entire first recording layer that is the recording layer on which the information is to be recorded first; and
the boundary detection apparatus further comprises a control device which controls the first moving device, the second moving device, and the third moving device to detect the boundary from the other recording layers than the first recording layer, when the information has been recorded on the entire first recording layer.

16: The boundary detection apparatus according to claim 7, wherein:
the recording medium is a recording medium that is formed with n (n being a natural number of 3 or larger) of stacked recording layers;
the detecting device detects whether the information has been recorded on a mth (m being a natural number of 3 or larger; m≦n) recording layer on which the information is to be recorded mth in the recording medium; and
the boundary detection apparatus further comprises a control device which controls the first moving device, the second moving device, and the third moving device to detect the boundary from the recording layers on which the information is to be recorded from first through (m−1)th in the recording medium, when the information has not been recorded on the mth recording layer.

17: The boundary detection apparatus according to claim 7, wherein:
the recording medium is a recording medium that is formed with n (n being a natural number of 2 or larger) of stacked recording layers;
the detecting device detects whether the information has been recorded on a mth (m being a natural number and m<n) recording layer on which the information is to be recorded mth in the recording medium; and
the boundary detection apparatus further comprises a control device which controls the first moving device, the second moving device, and the third moving device to detect the boundary from the recording layers on which the information is to be recorded in mth and later layers in the recording medium, when the information has been recorded on the mth recording layer.

18: The boundary detection apparatus according to claim 17, wherein
the control means further comprises a control device which controls the first moving device, the second moving device, and the third moving device to detect the boundary from the recording layers on which the information is to be recorded in (m+1)th and later layers in the recording medium, when the information has been recorded on the entire mth recording layer.

19: A boundary detection method for detecting a boundary between a recorded area in which information is recorded and a non-recorded area in which the information is not recorded on a recording medium that has a format in which information recording is performed in a predetermined direction,
the boundary detection method comprising:
a detecting step process of detecting whether the information has been recorded in a recordable area of the recording medium, the detecting step being performed by a detecting device which detects the information from the recording medium;
the first moving process of moving the detecting device to one of dividing points that are set by dividing stepwise the recordable area by a predetermined dividing number, and moving the detecting device to another one of the dividing points located ahead of the one of the dividing points seen in the predetermined direction from the dividing position after moving when the detecting device detects that the information has been recorded at the point after the movement, the moving of the detecting device being repeated for the plurality of the dividing points;
the second moving process of moving the detecting device to another one of the dividing points located on the opposite side of the one of the dividing points for which it is detected that the information has not been recorded in the predetermined direction when the detecting device detects that the information has not been recorded at the one of the dividing points during the movement of the detecting device in the first moving process, the moving of the detecting means being repeated for the plurality of the dividing points located on the opposite side in the predetermined direction; and
the third moving process of further moving the detecting device from the dividing point of the moved detecting device to which the detecting device has been moved in the first moving process or the second moving process, and detecting the boundary.

20: An information recording medium on which a boundary detection program is recorded in such a manner that the program can be read by a computer,
the boundary detection program being executed in the computer provided in a boundary detection apparatus that detects a boundary between a recorded area in which information has been recorded and a non-recorded area in which the information has not been recorded on a recording medium that has a format in which information recording is performed in a predetermined direction,
the boundary detection program being executed to cause the computer to function as:
a first moving device which moves a detecting device which determines whether the information has been recorded in a recordable area of the recording medium, to one of dividing points that are set by dividing stepwise the recordable area by a predetermined dividing number, the first moving device moving the detecting device to another one of the dividing points located ahead of the one of the dividing points seen in the predetermined direction from the dividing position after moving when the detecting device detects that the information has been recorded at the point after the movement, the first moving device repeating the moving of the detecting device for the plurality of the dividing points;
a second moving device which moves the detecting device to another one of the dividing points located on the opposite side of the one of the dividing points for which it is detected that the information has not been recorded in the predetermined direction when the detecting device detects that the information has not been recorded at the one of the dividing points during the movement of the detecting device by computer which functions as the first moving device, the second moving device repeating the moving of the detecting device for the plurality of the dividing points located on the opposite side in the predetermined direction; and
a third moving device which further moves the detecting device from the dividing point of the moved detecting device to which the detecting device has been moved by the computer functioning as the first moving device or the computer functioning as the second moving device, and detecting the boundary.

21. (canceled)
